(19) United States
(12) Patent Application Publication
(10) Pub. No.: US 2025/0179666 A1
(43) Pub. Date: Jun. 5, 2025

(54) METHOD FOR OPERATING AN ELECTROLYSIS SYSTEM

(71) Applicant: Siemens Energy Global GmbH & Co. KG, München (DE)

(72) Inventor: Dirk Wall, Mülheim (DE)

(21) Appl. No.: 18/549,194

(22) PCT Filed: Jan. 31, 2022
(86) PCT No.: PCT/EP2022/052165

§ 371 Date: Feb. 26, 2025

(30) Foreign Application Priority Data
Mar. 17, 2021 (DE) 10 2021 202 576.5

(51) Int. Cl. C25B 9/67; C25B 1/04; C25B 15/08

(52) U.S. Cl. CPC C25B 9/67; C25B 1/04; C25B 15/085

(57) ABSTRACT

Embodiments include a method for operating an electrolysis system. Aspects include supplying service water to a water treatment system and purifying and deionizing the service water in the water treatment system to create deionized water and ion-containing wastewater. Aspects also include supplying the deionized water from the water treatment system to an electrolyzer and supplying the ion-containing wastewater from the water treatment system to a cooling device. A waste heat generated by the electrolyzer is dissipated by the cooling device.

### BACKGROUND

The invention relates to an electrolysis system having an electrolyzer for producing hydrogen with the aid of electric current, wherein a cooling device having a cooling circuit is used to be able to dissipate the waste heat arising during the process in the electrolyzer.

Electrolysis systems are known in various embodiments from the prior art. The central component of the electrolysis system is the electrolyzer, wherein generally either a so-called alkaline electrolyzer or a so-called PEM electrolyzer is used. In both cases, it is necessary for pure water, which is nonconductive if possible, to be supplied to the electrolyzer for the electrolysis. For this purpose, in general a water treatment having deionization is used for this purpose. More strongly loaded ion-containing wastewater necessarily emerges during the deionization, which is also discharged as such “wastewater.”

In the process of the electrolysis, waste heat arises, because of which generally a coolant in turn flows through the electrolyzer. This coolant is cooled down again in a cooling device. In larger systems, a noticeable amount of waste heat arises, so that there is a requirement for sufficient cooling performance of the cooling device.

To solve this problem, for example, electrically operated fans are used to thus assist convection. However, the additional power consumption arising for the electrolysis is disadvantageous in this case. Furthermore, the ambient temperature limits the achievable temperature of the coolant, which can represent a problem in particular in areas typically having high outside temperatures.

### SUMMARY

Embodiments of the present disclosure are directed to a method for operating an electrolysis system. According to an aspect, the method includes supplying service water to a water treatment system and purifying and deionizing the service water in the water treatment system to create deionized water and ion-containing wastewater. The method also includes supplying the deionized water from the water treatment system to an electrolyzer and supplying the ion-containing wastewater from the water treatment system to a cooling device. A waste heat generated by the electrolyzer is dissipated by the cooling device.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an electrolysis system; and

FIG. 2 depicts a block diagram of an electrolysis system in accordance with one or more embodiments of the present disclosure.

### DETAILED DESCRIPTION

In one embodiment, a waste heat from the electrolyzer is supplied directly to a water treatment. In this way, supplied untreated water is heated using the waste heat to assist the deionization. Depending on the local conditions, the high level of water consumption is advantageous or disadvantageous in this solution. This solution can insofar reasonably be used if the additional water can be supplied to another use.

In alternative embodiments, evaporative cooling is used, by which a high cooling performance can be achieved without significant energy use. In particular, it is therefore possible to cool down the coolant to below the ambient temperature. Obviously, a water supply is required in this case to enable the wet cooling.

The use of electrolysis systems suggests itself in particular if current generated using regenerative energy sources and here in particular by means of photovoltaics can be used. Accordingly, larger dimensioned electrolysis systems are used in particular in areas having a high level of sunshine. This is often connected to high ambient temperatures and lesser availability of water. The problem is connected thereto that convection cooling causes a high-power loss due to the fans used. Furthermore, a desired low temperature of the coolant is sometimes not reachable using convection cooling. Therefore, evaporative cooling is generally used, which worsens the problem of water scarcity and causes high water costs, however.

The object of the present invention is to improve the yield of hydrogen in relation to the costs.

The electrolysis system in question includes an electrolyzer, where hydrogen and oxygen are produced from water using electrical energy during operation of the electrolysis system.

For this purpose, a water supply which provides service water is required first. Since high demands are placed on the purity and minimal conductivity, a water treatment is furthermore required. This is accordingly connected to the water supply, so that in operation of the electrolysis system, service water is conveyed to the water treatment. In the water treatment, the service water is purified if necessary and deionized in any case. Deionized ultrapure water—referred to hereafter as deionized water—is produced accordingly.

It is to be noted in this case that the deionized water is not necessarily pure H2O. Rather, the deionized water has the water quality which has the necessary requirements for purity for use in electrolysis and in particular the least possible presence of conductive ions.

Ion-containing wastewater necessarily arises in the process of the deionization and thus the separation of ions from the service water.

The water treatment is connected to the electrolyzer, wherein the deionized water is supplied to the electrolyzer in operation of the electrolysis system.

Furthermore, the electrolysis system of the type in question includes a cooling device. The electrolyzer generates waste heat, which has to be dissipated, in operation of the electrolysis system. For this purpose, the electrolyzer is connected to the cooling device such that the waste heat arising in the electrolyzer can be dissipated by the cooling device.

It is now provided according to the invention that the water treatment is also connected to the cooling device, wherein the ion-containing wastewater arising in the water treatment is supplied to the cooling device for cooling purposes.

Up to this point, it has been rejected as fundamentally impermissible to use the ion-containing wastewater arising in the water treatment further within the electrolysis system, since the quality is considered completely inadequate.

In contrast, however, the ion-containing wastewater is used for the cooling for the solution according to the invention. The water consumption of the electrolysis system can be reduced in this way, so that in particular in areas having critical water supply, the acceptance for an electrolysis system can be improved and the costs for the water supply obviously decrease.

A cooling circuit, which connects the electrolyzer to the cooling device, is advantageously used for the cooling. A cooled coolant is supplied to the electrolyzer here, which heats up due to the operation of the electrolyzer. The heated coolant is supplied in the circuit to the cooling device. After it has been cooled down again there, it is conducted back to the electrolyzer.

In the method for operating the electrolysis system, it is particularly advantageous here if the higher strain due to the ion-containing wastewater is taken into consideration. For this purpose, the maintenance interval is advantageously shortened by at least 20% starting from a comparison period of time. The comparison period of time is in this case that theoretical maintenance interval which is suitable if the service water is used directly for the cooling instead of the ion-containing wastewater with identical existing system technology.

It can be provided that further measures are taken to lengthen the maintenance interval, which would not have been performed if service water had been used directly. That system having the further measures is similarly used in this case for the determination of the comparison period of time.

The shortening of the maintenance interval does result in higher costs and possibly in more frequent shutdown times—or as a result in higher installation costs and running costs upon compensation by further measures, however, the higher maintenance costs have less importance in areas with restricted water resources than the otherwise required water consumption.

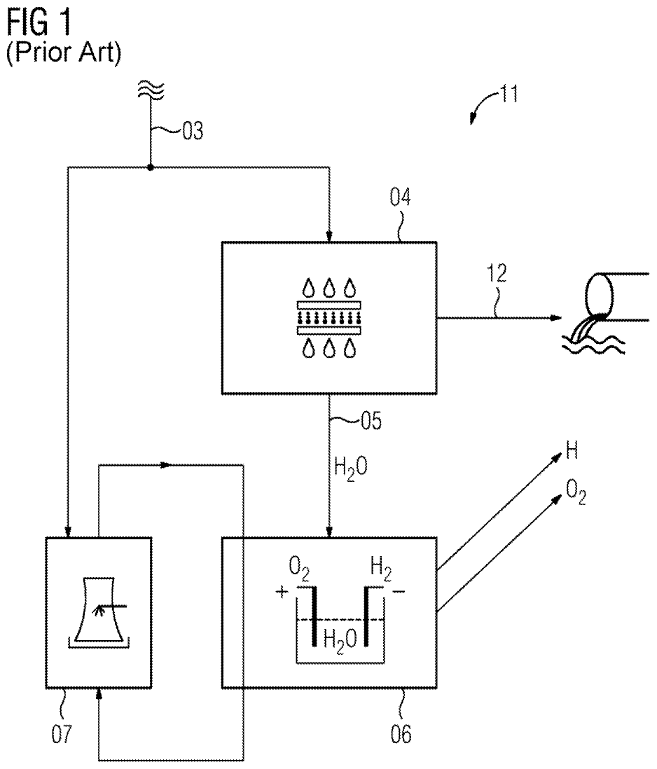

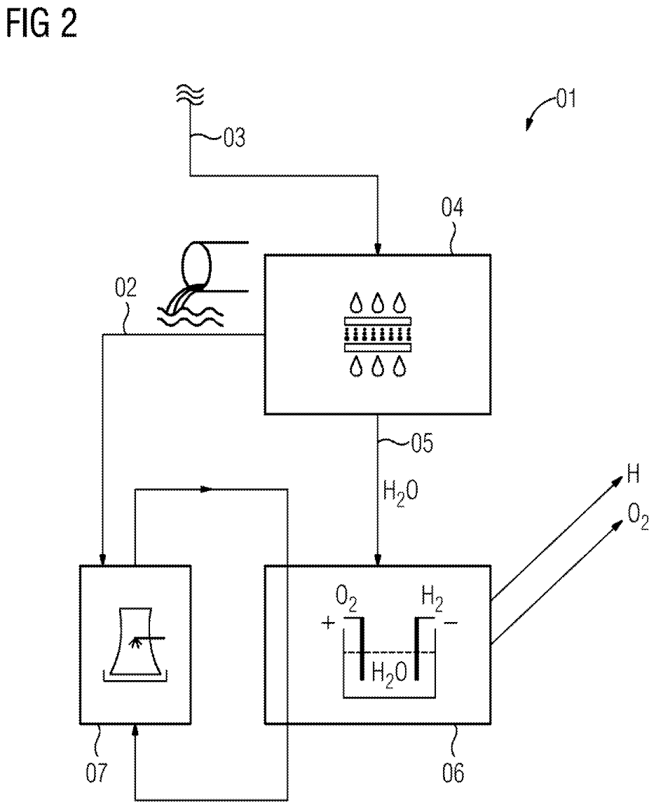

An embodiment of an electrolysis system according to the prior art—see FIG. 1—and an electrolysis system according to the invention—see FIG. 2—are outlined schematically hereinafter in the following figures.

Both embodiments of an electrolysis system 11 according to the prior art—FIG. 1—and an electrolysis system 01 according to the invention comprise as the essential element the electrolyzer 06. The educt water H2O is split into the products hydrogen H2 and oxygen O2 here using electric current. Water—i.e., the deionized water—is obviously required for this process.

For this purpose, the figures outline supply with service water 03, which leads to a water treatment 04. In this 04 the service water 03 is possibly purified and in any case deionized. Deionized water 05 is provided in this way, which 05 is supplied to the electrolyzer 06.

Waste heat, which has to be dissipated, arises due to the process of electrolysis. For this purpose, the electrolyzer 06 is connected via a cooling circuit to a cooling device 07. A coolant previously heated in the electrolyzer 06 is cooled down again therein 07.

Ion-containing wastewater 02, 12 necessarily emerges during the water treatment.

In this case—as outlined in FIG. 1—it is provided as a standard feature that the wastewater 12 is discharged from the electrolysis system 11. However, it is necessary to supply the cooling device 07 with water, in particular for evaporative cooling, for effective cooling, in particular in hot areas. For this purpose, the cooling device 07 is typically connected to the water supply, so that service water 03 is supplied to the cooling device 07.

In contrast, it is now provided according to the invention—as outlined in FIG. 2—that the ion-containing wastewater 02 from the water treatment is supplied to the cooling device 07. In this case, it will generally become necessary to shorten the maintenance intervals, but the water consumption can be reduced in this way.

1. A method for operating an electrolysis system, the method comprising:
supplying service water to a water treatment system;
purifying and deionizing the service water in the water treatment system to create deionized water and ion-containing wastewater;
supplying the deionized water from the water treatment system to an electrolyzer; and
supplying the ion-containing wastewater from the water treatment system to a cooling device,
wherein a waste heat generated by the electrolyzer is dissipated by the cooling device.

2. The method as claimed in claim 1, wherein a coolant flows in a circuit through the electrolyzer and the cooling device and wherein the coolant is heated in the electrolyzer and cooled in the cooling device.

3. The method as claimed in claim 1, wherein the cooling device comprises an evaporative cooling device.

4. The method as claimed in any one of claim 1, wherein deposits are removed in the cooling device at regular maintenance intervals, wherein the maintenance interval is shortened by at least 20% of the duration of a comparison period of time, wherein the comparison period of time is that interval after which the deposits are removed if exclusively service water is supplied to the cooling device.
